(19) United States
(12) Patent Application Publication
(10) Pub. No.: US 2020/0108420 A1
(43) Pub. Date: Apr. 9, 2020

(54) Keyboard cleanliness maintenance device

(71) Applicant: Meijun Wu, Zibo City (CN)

(72) Inventor: Meijun Wu, Zibo City (CN)

(21) Appl. No.: 16/706,814

(22) Filed: Dec. 8, 2019

(30) Foreign Application Priority Data
Aug. 27, 2019 (CN) 2019107960014

(51) Int. Cl. B08B 1/00; B08B 1/04; B08B 5/04

(52) U.S. Cl. CPC B08B 1/002; B08B 5/04; B08B 1/04

(57) ABSTRACT

The invention discloses a keyboard cleanliness maintenance device, which includes a cleaning block. The cleaning block is provided with a working chamber. The working chamber is provided with a cleaning mechanism. The cleaning mechanism includes a left end fixed to the working chamber. A wall motor, a suction mechanism is provided on the right side of the cleaning mechanism, the suction mechanism includes a garbage frame fixed on the upper end wall of the working chamber, a disinfection mechanism is provided on the right side of the suction mechanism, and the disinfection mechanism includes a alcohol frame on the upper end wall of the working cavity is simple to operate. The device removes the garbage on the keyboard surface from the keyboard by means of friction, rotation and blowing, and sucks away a small amount of garbage. The device avoids cleaning the keyboard surface by tapping. It can reduce the wear on the keyboard. After the garbage is cleaned up, the device can also apply alcohol to the surface of the keyboard, which can greatly sterilize the keyboard.

### CROSS REFERENCES TO RELATED APPLICATIONS

The present application claims priority from Chinese application No. 2019107960014 filed on Aug. 27, 2019 which is hereby incorporated by reference in its entirety.

### TECHNICAL FIELD

The invention relates to the field of keyboard cleaning and specifically relates to a keyboard cleanliness maintenance device.

### BACKGROUND OF THE INVENTION

With the increasing popularity of desktop computers, the issue of keyboard cleanliness has become more and more important. When cleaning the keyboard, because there is a gap between the keycaps of the keyboard, it is very inconvenient to clean directly, and the keycaps are pulled out. Cleaning is time consuming and the keyboards in public places, even after cleaning, there are still a lot of bacteria on the surface of the keyboard. Traditional cleaning methods cannot play a role in sterilization.

### BACKGROUND OF THE INVENTION

The technical problem to be solved by the present invention is to provide a keyboard cleanliness maintenance device, which overcomes the problems that the keyboard is not easy to clean, and there are still a lot of bacteria on the keyboard after cleaning.

The present invention is achieved by the following technical solutions.

A keyboard cleanliness maintenance device according to the present invention includes a cleaning block. The cleaning block is provided with a working chamber. The working chamber is provided with a cleaning mechanism. The cleaning mechanism includes a left end wall fixed to the working chamber. A motor, a driving shaft is rotatably provided on the right end surface of the motor, a disk is provided on the lower side of the working cavity, and a brush is fixed on the lower end of the disk, and the driving shaft can drive the brush to rotate. The rotation of the brush can clean dirt on the keyboard surface;

A suction mechanism is provided on the right side of the cleaning mechanism, and the suction mechanism includes a garbage frame fixed on the upper end wall of the working cavity. The garbage frame is provided with a garbage cavity. A cleaning pipe is arranged in the feeding port to move up and down, and the garbage cleaned from the keyboard can be stored in the garbage cavity;

A disinfection mechanism is provided on the right side of the suction mechanism. The disinfection mechanism includes an alcohol frame fixed on the upper end wall of the working cavity. The alcohol frame is provided with an alcohol cavity and an isolation cavity, and the alcohol cavity and the isolation cavity. A partition is provided between the partitions, and a through hole is provided through the partition. The through hole communicates the alcohol cavity and the isolation cavity, and a rear wall of the alcohol cavity is provided with a moving groove.

Preferably, the cleaning mechanism further includes a first bevel gear, the first bevel gear is fixedly disposed on the driving shaft, a lower end wall of the working cavity is rotatably provided with a vertical shaft, and an upper end surface of the vertical shaft is fixedly provided There is a second bevel gear, the second bevel gear meshes with the first bevel gear, a disk is fixedly provided on the lower end surface of the vertical shaft, and a brush is fixed on the lower end surface of the disk.

Preferably, a vertical groove is provided on the rear end surface of the working cavity, and a vertical plate can be moved up and down in the vertical groove. A vertical cavity is provided in the vertical plate. A left end wall of the vertical cavity can be rotatably provided with a horizontal axis. A fan blade is fixed on the left end surface of the horizontal axis, a rotating shaft is rotatably provided on the upper end wall of the vertical cavity, and a third bevel gear is fixed on the lower end surface of the rotating shaft. A bevel gear meshes, a fifth bevel gear is fixed on the upper end surface of the rotating shaft, a telescopic spring is connected between the end surface of the vertical plate and the upper end wall of the vertical groove, and a connecting rod is fixed on the right end surface of the vertical plate. A sixth bevel gear is fixed on the right end face of the driving shaft.

Preferably, the suction mechanism further includes a first pulley fixed on the rotating shaft, a belt is wound around the first pulley, and two rotation grooves are symmetrically provided on the left and right end walls of the feeding port. A pin is fixed on the rear end wall of the rotation groove, and a isolation rod is rotatably provided on the pin. A torsion spring is provided between the pin and the isolation rod. A cleaning cavity and a rotation cavity are provided in the cleaning tube. A rotating cavity is located on the upper side of the cleaning cavity, and the cleaning cavity is in communication with the rotating cavity. Two upper feed holes are provided through the upper end wall of the rotating cavity, and a driven shaft is provided on the upper end wall of the rotating cavity. A second pulley and a cleaning fan blade are fixedly arranged on the driven shaft from top to bottom, the belt is wound around the second pulley, and the lower end wall of the working cavity is provided with isolation grooves vertically. The cleaning tube can be moved up and down in the isolation tank, and the connecting rod is fixed on the left end surface of the cleaning tube.

Preferably, the disinfection mechanism further includes a cotton block, and the cotton block is fixedly provided on the lower end surface of the hollow rod. Vertical holes are provided in the hollow rod, and left and right end walls of the vertical hole are provided with outflow grooves. The lower end wall of the working chamber is provided with an upwardly-opening sealing groove, and the hollow rod can be moved up and down in the moving groove. A spring is arranged between the upper end surface of the hollow rod and the upper end wall of the alcohol cavity. A first rubber block and a second rubber block are fixedly disposed, and the first rubber block is located on an upper side of the second rubber block.

Preferably, the fifth bevel gear can mesh with the sixth bevel gear after moving upward.

Preferably, the spring, the torsion spring and the telescopic spring are in a normal state.

Preferably, alcohol is contained in the isolation cavity and the alcohol cavity, and the first rubber block and the second rubber block can play a sealing role.

Preferably, a handle is fixed on the upper end surface of the working cavity, and a worker can hold the handle and use the device to clean the keyboard, which is very convenient.

The beneficial effect of the present invention is that the device is easy to operate. The rubbish on the keyboard surface is blown away from the keyboard by means of friction, rotation and blowing, and a small amount of garbage is sucked away. The device avoids cleaning the keyboard surface by tapping, which can reduce the keyboard After the waste is cleaned up, the device can also apply alcohol to the surface of the keyboard, which can greatly sterilize the keyboard.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic front view structural schematic diagram of an overall full section of a keyboard cleanliness maintenance device according to the present invention; FIG.

FIG. 2 is an enlarged schematic view of A in FIG. 1; FIG.

FIG. 3 is a schematic diagram in the direction of B-B in FIG. 1;

FIG. 4 is a schematic view in the direction C-C of a bottom view of the brush in FIG. 1.

### DETAILED DESCRIPTION OF THE INVENTION

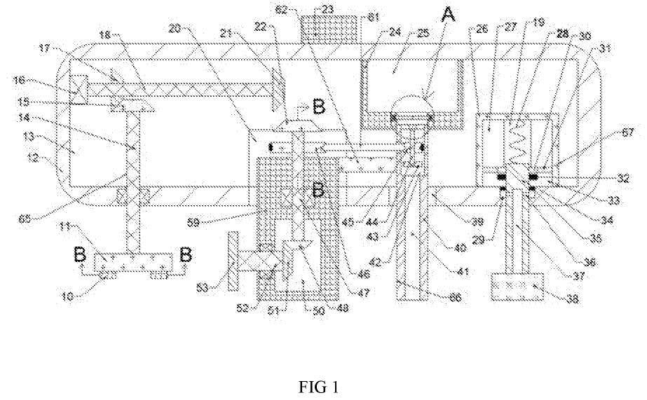

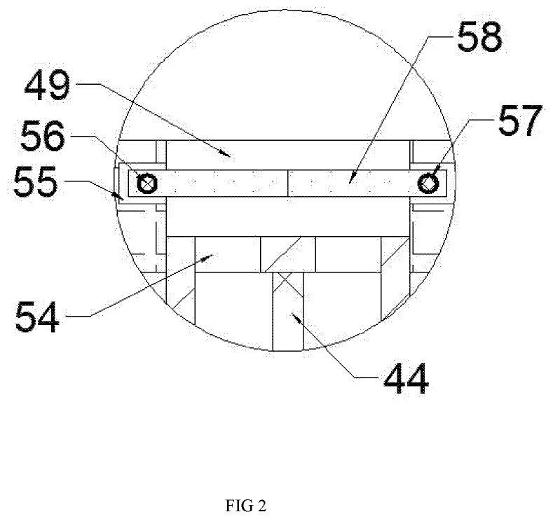

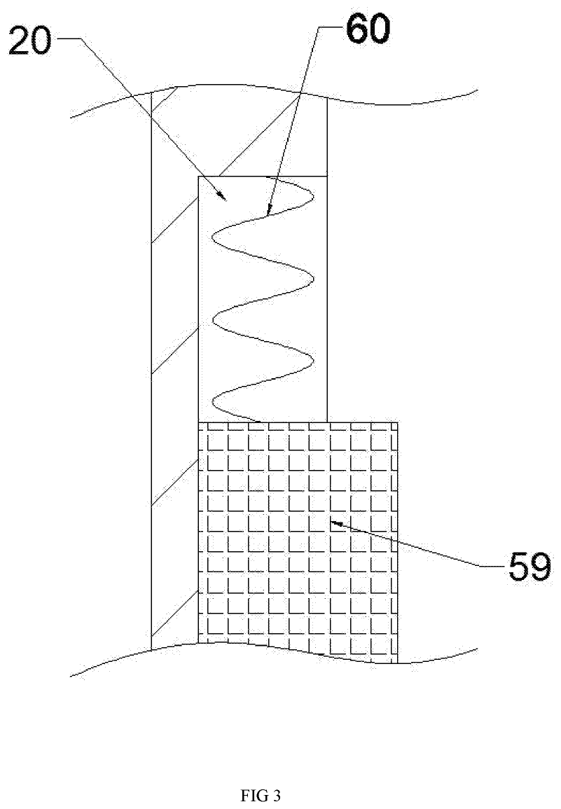

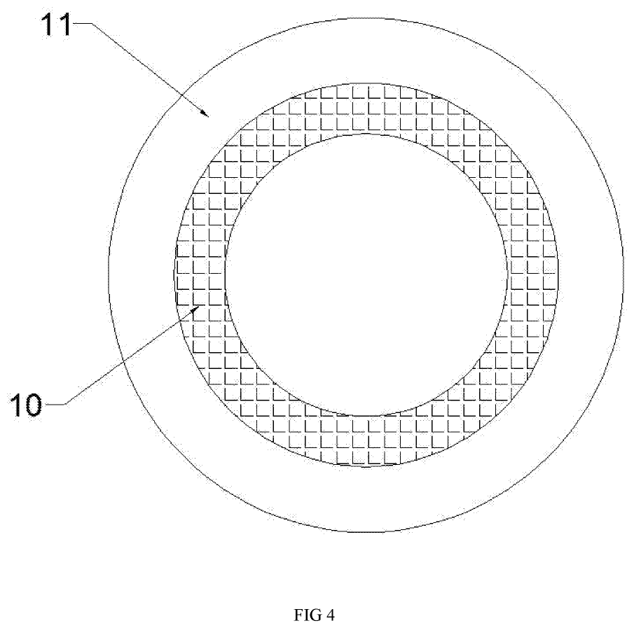

The present invention is described in detail below with reference to FIGS. 1-4. For convenience of description, the orientation described below is defined as follows: the up-down, left-right, front-back direction described below is consistent with the up-down, left-right, front-back direction of the projection relationship of FIG. 1 itself.

A schematic diagram of a mechanical mechanism for keyboard cleanliness maintenance equipment described in conjunction with FIGS. 1-4 includes a cleaning block 12 having a working chamber 13 therein and a cleaning mechanism 13 65. The cleaning mechanism 65 includes a motor 16 fixed on the left end wall of the working chamber 13, a right end surface of the motor 16 is rotatably provided with a driving shaft 18, and a disc 11 is provided on the lower side of the working chamber 13. A brush 10 is fixed on the lower end surface of the disc 11, and the rotation of the driving shaft 18 can drive the brush 10 to rotate, and the rotation of the brush 10 can clean the dirt on the keyboard surface;

A suction mechanism 66 is provided on the right side of the cleaning mechanism 65, and the suction mechanism 66 includes a garbage frame 24 fixed on the upper end wall of the working cavity 13, and a garbage cavity 25 is disposed in the garbage frame 24. The lower end wall is provided with a feeding port 49 penetrating up and down, and a cleaning pipe 40 is provided in the feeding port 49 to move up and down. The garbage cavity 25 can store the garbage cleaned from the keyboard;

A disinfection mechanism 67 is provided on the right side of the suction mechanism 66, and the disinfection mechanism 67 includes an alcohol frame 26 fixed on the upper end wall of the working chamber 13. The alcohol frame 26 is provided with an alcohol cavity 27 and an isolation cavity 33. A partition 31 is provided between the alcohol cavity 27 and the isolation cavity 33, and the partition 31 is provided with a through opening 30 penetrating up and down, and the through opening 30 communicates the alcohol cavity 27 and the isolation cavity 33. The rear end wall of the alcohol chamber 27 is provided with a moving groove 19.

Beneficially, the cleaning mechanism 65 is described in detail. The cleaning mechanism 65 further includes a first bevel gear 17 fixedly disposed on the driving shaft 18 and a lower end wall of the working cavity 13 A vertical shaft 14 is rotatably provided, and a second bevel gear 15 is fixed on an upper end surface of the vertical shaft 14. The second bevel gear 15 meshes with the first bevel gear 17. A lower end surface of the vertical shaft 14 is fixedly provided. There is a disc 11, and a brush 10 is fixed on the lower end surface of the disc 11;

A vertical groove 20 is provided on the rear end surface of the working cavity 13, and a vertical plate 59 is vertically movable in the vertical groove 20. A vertical cavity 50 is provided in the vertical plate 59, and a left end wall of the vertical cavity 50 is rotatably provided. There is a horizontal shaft 52, a fan blade 53 is fixed on the left end surface of the horizontal shaft 52, a rotating shaft 47 is rotatably provided on the upper end wall of the vertical cavity 50, and a third bevel gear 48 is fixed on the lower end surface of the rotating shaft 47. The third bevel gear 48 meshes with the fourth bevel gear 51, a fifth bevel gear 22 is fixed on the upper end surface of the rotating shaft 47, and the upper end surface of the vertical plate 59 is connected with the upper end wall of the vertical groove 20. There is a telescoping spring 60, a connecting rod 62 is fixed on the right end surface of the vertical plate 59, and a sixth bevel gear 21 is fixed on the right end surface of the driving shaft 18.

Advantageously, the suction mechanism 66 is described in detail. The suction mechanism 66 further includes a first pulley 46 fixed on the rotating shaft 47, and a belt 61 is wound around the first pulley 46. The left and right end walls of the feeding port 49 are symmetrically provided with two rotation grooves 55. A pin 56 is fixed on the rear wall of the rotation groove 55, and a spacer 58 is rotatably provided on the pin 56. A torsion spring 57 is provided between the isolation rods 58. The cleaning tube 40 is provided with a cleaning cavity 41 and a rotating cavity 42. The rotating cavity 42 is located on the upper side of the cleaning cavity 41, and the cleaning cavity 41 and the rotating cavity 42 is communicated, and the upper end wall of the rotating cavity 42 is provided with two feeding holes 54 vertically. The upper end wall of the rotating cavity 42 is provided with a driven shaft 44 which is fixedly arranged from top to bottom in turn. There are a second pulley 45 and a cleaning fan blade 43. The second pulley 45 is wound with the belt 61, and a lower end wall of the working cavity 13 is provided with an isolation groove 39 penetrating up and down. The cleaning pipe 40 is provided in movement, and the left end surface of the cleaning pipe 40 is fixedly provided with the connecting rod 62.

Beneficially, the disinfection mechanism 67 is described in detail. The disinfection mechanism 67 further includes a cotton block 38. The cotton block 38 is fixedly provided on the lower end surface of the hollow rod 34, and a vertical hole 37 is provided in the hollow rod 34. The left and right end walls of the vertical hole 37 are provided with outflow grooves 36 on the left and right. The lower end wall of the working cavity 13 is provided with an upwardly-opening sealing groove 29. The hollow groove 34 is provided in the moving groove 19 to move up and down. A spring 28 is provided between the upper end surface of the hollow rod 34 and the upper end wall of the alcohol chamber 27, and a first rubber block 32 and a second rubber block 35 are fixed on the hollow rod 34. The upper side of the second rubber block 35 is described.

Advantageously, the fifth bevel gear 22 can mesh with the sixth bevel gear 21 after moving upward.

Advantageously, the spring 28, the torsion spring 57 and the telescopic spring 60 are in a normal state.

Beneficially, the isolation cavity 33 and the alcohol cavity 27 are filled with alcohol, and the first rubber block 32 and the second rubber block 35 can play a sealing role.

Beneficially, a handle 23 is fixed on the upper end surface of the working cavity 13, and a worker can hold the handle 23 and use the device to clean the keyboard, which is very convenient.

The sequence of mechanical actions of the entire device:

(1) When the keyboard needs to be cleaned, hold the handle 23 with one hand and fix the keyboard with the other hand. Align the lower side of the device with the right side of the keyboard. Use the hand to drive the handle 23 to push the device downward. The keyboard pressure moves upward, the fifth bevel gear 22 moves upward with the horizontal axis 52, the fifth bevel gear 22 meshes with the sixth bevel gear 21, and the vertical plate 59 drives the cleaning pipe 40 to move upward through the connecting rod 62.

(2) The cleaning pipe 40 is fixed upward, pushing the two isolation rods 58 to rotate, and the garbage cavity 25 is in communication with the feeding hole 54.

(3) Start the motor 16 and push the device to the left. The driving shaft 18 rotates with the motor 16. The driving shaft 18 drives the first bevel gear 17 to rotate, the first bevel gear 17 drives the second bevel gear 15 to rotate, and the second bevel gear 15 The vertical shaft 14 drives the disc 11 to rotate, and the brush 10 rotates following the disc 11, and the brush 10 rotates to clean up the garbage on the keyboard surface.

(4) The sixth bevel gear 21 rotates with the driving shaft 18, the sixth bevel gear 21 drives the fifth bevel gear 22 to rotate, the fifth bevel gear 22 drives the third bevel gear 48 to rotate through the rotation shaft 47, and the third bevel gear 48 has a core Drive the fourth bevel gear 51 to rotate. The fourth bevel gear 51 drives the fan blade 53 to rotate through the horizontal shaft 52. The fan blade 53 rotates to blow away the garbage on the keyboard surface. The first pulley 46 rotates with the rotation shaft 47, and the rotation shaft 47 The second belt pulley 45 is driven to rotate by the friction of the belt 61. The second belt pulley 45 drives the cleaning fan blade 43 to rotate through the driven shaft 44. The cleaning fan blade 43 rotates to suck the garbage on the keyboard surface into the garbage cavity 25.

(5) The cotton block 38 moves upwards under pressure, and the hollow rod 34 moves upward with the cotton block 38. The hollow rod 34 drives the second rubber block 35 and the first rubber block 32 to move upward, and the first rubber block 32 blocks the opening 30. The second rubber block 35 moves upward, the alcohol in the isolation cavity 33 flows into the vertical hole 37 through the sealing groove 29 and the outflow groove 36, and finally flows onto the cotton block 38. When the cotton block 38 passes the keyboard surface, the keyboard is disinfected.

(6) After cleaning, turn off the motor and lift up the device. The vertical plate 59 and the cleaning tube 40 move downward, the cotton block 38 moves downward, the second rubber block 35 closes the sealing groove 29, and the first rubber block 32 leaves the port 30, and the isolation cavity 33 is filled with alcohol.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A device for maintaining keyboard cleanliness, including a cleaning block, characterized in that:
a working chamber is provided in the cleaning block, and a cleaning mechanism is provided in the working chamber. The cleaning mechanism includes a motor fixed to the left end wall of the working chamber. A right end of the motor is rotatably provided with a driving shaft. A disk is provided on the lower side of the working chamber, and a brush is fixed on the lower end surface of the disk. The rotation of the driving shaft can drive the brush to rotate, and the rotation of the brush can clean dirt on the keyboard surface;
a suction mechanism is provided on the right side of the cleaning mechanism, and the suction mechanism includes a garbage frame fixed on the upper end wall of the working cavity. The garbage frame is provided with a garbage cavity. A cleaning pipe is arranged in the feeding port to move up and down, and the garbage cleaned from the keyboard can be stored in the garbage cavity;
a disinfection mechanism is provided on the right side of the suction mechanism. The disinfection mechanism includes an alcohol frame fixed on the upper end wall of the working cavity. The alcohol frame is provided with an alcohol cavity and an isolation cavity, and the alcohol cavity and the isolation cavity. A partition is provided between the partitions, and a through hole is provided through the partition. The through hole communicates the alcohol cavity and the isolation cavity, and a rear wall of the alcohol cavity is provided with a moving groove.

2. The keyboard cleanliness maintenance device according to claim 1, wherein the cleaning mechanism further comprises a first bevel gear, and the first bevel gear is fixedly disposed on the driving shaft, and A vertical shaft is rotatably provided on the lower end wall of the working cavity, and a second bevel gear is fixed on the upper end surface of the vertical shaft. The second bevel gear meshes with the first bevel gear. The lower end surface of the vertical shaft is fixedly provided. A disc, a brush is fixed on the lower end surface of the disc.

3. A device for maintaining keyboard cleanliness according to claim 2, characterized in that: a vertical groove is provided at the rear end surface of the working cavity, and a vertical plate can be moved up and down in the vertical groove, and the vertical A vertical cavity is arranged in the board, and the left end wall of the vertical cavity is rotatably provided with a horizontal axis. The left end of the horizontal axis is fixed with a fan blade. The upper end wall of the vertical cavity is rotatably provided with a rotating shaft. A third bevel gear is fixed on the end face, the third bevel gear meshes with the fourth bevel gear, a fifth bevel gear is fixed on the upper end face of the rotating shaft, and the upper end of the vertical plate and the upper end of the vertical groove A telescopic spring is connected between the walls, a connecting rod is fixed on the right end face of the vertical plate, and a sixth bevel gear is fixed on the right end face of the driving shaft.

4. The keyboard cleanliness maintenance device according to claim 3, wherein the suction mechanism further comprises a first pulley fixed on the rotating shaft, and the first pulley is wound on the first pulley. There is a belt, and the left and right end walls of the feeding port are symmetrically provided with two rotating grooves. Pins are fixed on the rear wall of the rotating groove. The pins are rotatably provided with isolation bars. The pins and the isolation bars A torsion spring is provided between the cleaning tube and a rotating cavity. The rotating cavity is located on the upper side of the cleaning cavity. The cleaning cavity is in communication with the rotating cavity. There are two feeding holes. A driven shaft is provided on the upper end wall of the rotating cavity. A second pulley and a cleaning fan are fixedly arranged on the driven shaft from top to bottom. The belt is wound, and the lower end wall of the working cavity is provided with isolation grooves vertically. The isolation groove is provided with a cleaning pipe that can be moved up and down, and the connecting rod is fixed on the left end surface of the cleaning pipe.

5. The device for maintaining keyboard cleanliness according to claim 1, wherein the disinfection mechanism further comprises a cotton block, and the cotton block is fixedly provided on the lower end of the hollow rod, and the hollow rod is provided inside There are vertical holes, and the left and right end walls of the vertical holes are provided with outflow slots on the left and right. The lower end wall of the working chamber is provided with an upwardly-opening sealing groove. The hollow groove can be moved up and down in the moving groove. A spring is provided between the upper end surface of the rod and the upper end wall of the alcohol chamber, and a first rubber block and a second rubber block are fixed on the hollow rod, and the first rubber block is located on the upper side of the second rubber block.

6. The keyboard cleanliness maintenance device according to claim 3, wherein the fifth bevel gear can be engaged with the sixth bevel gear after moving upward.

7. The keyboard cleanliness maintenance device according to claim 5, wherein the spring, the torsion spring and the telescopic spring are in a normal state.

8. The device for maintaining keyboard cleanliness according to claim 5, characterized in that alcohol is contained in the isolation cavity and the alcohol cavity, and the first rubber block and the second rubber block can play a sealing role.

9. A keyboard cleanliness maintenance device according to claim 5, characterized in that: a handle is fixed on the upper end surface of the working cavity, and a staff member can hold the handle and use the device to clean the keyboard. Convenience.
